(19) United States
(12) Patent Application Publication
(10) Pub. No.: US 2015/0319485 A1
(43) Pub. Date: Nov. 5, 2015

(54) METHOD AND SYSTEM FOR STREAMING MULTIMEDIA CONTENTS IN A WI-FI NETWORK

(71) Applicant: SAMSUNG ELECTRONICS CO., LTD., Suwon-si, Gyeonggi-do (KR)

(72) Inventors: Kiran Bharadwaj VEDULA, Bangalore (IN); Jun-Hyung KIM, Gyeonggi-do (KR)

(73) Assignee: Samsung Electronics Co., Ltd., Gyeonggi-do (KR)

(21) Appl. No.: 14/650,420

(22) PCT Filed: Dec. 9, 2013
(86) PCT No.: PCT/KR2013/011359

§ 371 Date: Jun. 8, 2015

(30) Foreign Application Priority Data
Dec. 7, 2012 (IN) 5104/CHE/2012

(51) Int. Cl. H04N 21/4363; H04N 21/6437; H04N 21/2665; H04N 21/41; H04N 21/222

(52) U.S. Cl. CPC H04N 21/43637; H04N 21/4126; H04N 21/222; H04N 21/2665; H04N 21/6437

(57) ABSTRACT

A method and system for simultaneously streaming multimedia contents from plurality of sources within a group by establishing one or more Wireless Fidelity Display (WFD) sessions with a sink is disclosed. The method enables the sink to share the display screen (screen) of the sink among a first source and one or more second sources in the group to display the video of the multimedia content. The method enables the sink to select audio of the multimedia content from one among the first source and one or more second sources in the group. The method enables the sink, the first source and one or more second sources in the group to select mode of operation for streaming of the multimedia contents to the sink.

### TECHNICAL FIELD

The present invention relates to relates to streaming multimedia contents in the Wi-Fi network.

### BACKGROUND ART

With technological progress in Wireless Fidelity (Wi-Fi), the Wi-Fi has expanded in application dimension, moving from its core networking market into other uses. Most of the modern electronic devices such as smart phones, tablets, peripherals, TVs, set-top boxes and the like are equipped with Wi-Fi capabilities. Emerging Wi-Fi technology has come up with Wi-Fi Display (WFD) mechanism with ability to transmit multimedia content comprising audio-visual content over Wi-Fi network providing a cable-free revolution.

The WFD specification defines mechanisms for mirroring multimedia content between a WFD source device (source) and a WFD sink device (sink) by establishing a WFD session. The source captures the multimedia content being played, encodes, packetizes and streams it to the sink. The sink de-packetizes, decodes and displays the multimedia content on either the sink or a display connected to the sink. The WFD session is established when the source and the sink discover each other, interconnect using either Wi-Fi Peer to Peer (P2P) or Tunneled Direct Link Setup (TDLS), and know about each other capabilities through capability exchange and negotiation.

The existing Wi-Fi Display specification limits the WFD session to only a single source, a single primary sink with audio-video functionality and an optional coupling to a secondary sink limited to only audio functionality. The existing methods fail to handle multiple sources at the sink in an interoperable way. However, various multiuser scenarios such as multiplayer interactive gaming applications demand simultaneous streaming of multimedia content from multiple sources on to single sink

### DISCLOSURE OF INVENTION

### Technical Problem

The aspect of the embodiments herein is to provide a method and system that enables a first source and one or more second sources in a group to simultaneously stream multimedia contents to a sink after establishing one or more Wireless Fidelity Display (WFD) session with the sink.

Another aspect of the invention is to provide a method that enables the sink to share the display screen (screen) of the sink among the first source and one or more second sources in the group to display the video of the multimedia content.

Another aspect of the invention is to provide a method that enables the sink to select audio of the multimedia content from a source in the group to render the selected audio.

Another aspect of the invention is to provide a method that enables the sink, the first source and one or more second sources in the group to select mode of operation for simultaneous streaming of the multimedia contents to the sink.

### Solution to Problem

Accordingly the invention provides a method for streaming multimedia content in a Wireless Fidelity (Wi-Fi) network, wherein the method comprises discovering source association information by a sink during capability exchange between the sink and at least one of a first source and at least one second source after performing Device Discovery (DD) and Service Discovery (SD). The method further comprises establishing at least one Wi-Fi Display (WFD) session between the sink and at least one of the first source and the at least one second source for streaming the multimedia content in the Wi-Fi network. Thereafter, the method comprises displaying video of the multimedia content from the first source and the at least one second source by the sink, wherein screen of the sink is shared among at least one of the first source and the at least one second source. Furthermore, the method comprises rendering audio of the multimedia content by the sink after selecting the audio from one of the first source, the at least one second source.

Accordingly the invention provides a system for streaming multimedia content in a Wireless Fidelity (Wi-Fi) network, wherein the system comprises a first source, at least one second source and a sink. The system is configured to discover source association information by the sink by performing capability exchange between the sink and at least one of the first source and the at least one second source after performing Device Discovery (DD) and Service Discovery (SD). Further, the system is configured to establish at least one Wi-Fi Display (WFD) session between the sink and at least one of the first source and the at least one second source for streaming the multimedia content in the Wi-Fi network. Further, the system is configured to display video of the multimedia content from the first source and the at least one second source by the sink, wherein screen of the sink is shared among at least one of the first source and the at least one second source. Furthermore, the system is configured to render audio of the multimedia content by the sink after selecting the audio from one of the first source, the at least one second source.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

This invention is illustrated in the accompanying drawings, throughout which like reference letters indicate corresponding parts in the various figures. The embodiments herein will be better understood from the following description with reference to the drawings, in which:

FIG. 1 illustrates an example WFD environment with one or more sources in a group simultaneously streaming multimedia content to a sink by establishing one or more WFD sessions, according to embodiments as disclosed herein;

FIG. 2 illustrates a sequence diagram explaining formation of a pre-association group for establishing one or more WFD sessions in an associated mode of operation, according to embodiments as disclosed herein;

FIG. 3 illustrates a sequence diagram explaining establishment of one or more WFD sessions by one or more sources in the pre-associated group with the sink for the associated mode of operation, according to embodiments as disclosed herein;

FIG. 4a illustrates a sequence diagram for a multiplayer game by establishing one or more WFD sessions in the associated mode of transmission and FIG. 4b illustrates corresponding display screen of the sink, according to embodiments as disclosed herein;

FIG. 5a illustrates a sequence diagram explaining establishment of one or more WFD sessions for a post grouping mode in an unassociated mode of operation and, FIG. 5b, FIG. 5c illustrate corresponding display screens of the sink, according to embodiments as disclosed herein;

FIG. 6a illustrates a sequence diagram explaining establishment of one or more WFD sessions for a pre-grouping mode in the unassociated mode of operation and, FIG. 6b, FIG. 6c illustrate corresponding display screen of the sink, according to embodiments as disclosed herein; and

FIG. 7a illustrates a sequence diagram explaining establishment of one or more WFD sessions for a part display mode of operation and FIG. 7b illustrates corresponding display screen of the sink, according to embodiments as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The embodiments herein achieve a method and system to enable plurality of sources in a group to simultaneously stream multimedia contents to a sink after establishing one or more Wireless Fidelity Display (WFD) sessions or a Real Time Streaming Protocol (RTSP) session with the sink. The group of plurality of sources comprises a first source and one or more second sources as members of the group. The sink shares the display screen of the sink among the members of the group to display the video of the multimedia content. The sink selects audio of the multimedia content from a source in the group based on an audio intent value received from the members of the group. The sink then renders the selected audio from the source and indicates the corresponding source on the display screen.

In an embodiment, the source can be mobile phone, a smart phone, a tablet, a Personal Digital Assistant (PDA), a smart TV and similar electronic device that is WFD capable for streaming multimedia contents on the sink.

In an embodiment, the sink can be a television, a tablet, a laptop and any electronic device that is WFD capable for rendering the received audio and video from the WFD source.

The method provides various modes of operation for simultaneous streaming of the multimedia contents by the members in the group to the sink. In an embodiment, the modes of operation can be an associated mode, an unassociated mode and a part display mode. The unassociated mode comprises a post grouping mode and a pre-grouping mode of operation. The mode of operation defines the way a first source and one or more second sources among plurality of sources form the group for simultaneously streaming their multimedia contents on the screen of the sink.

There can be plurality of sources in the group. The number of sources streaming simultaneously on the sink is limited by one or more parameters such as maximum number of sources supported by the sink and such similar parameters.

Thus, the method enables applications such as multiplayer interactive gaming by enabling the sink to render video from plurality of sources and audio from one of the selected source in an interoperable way.

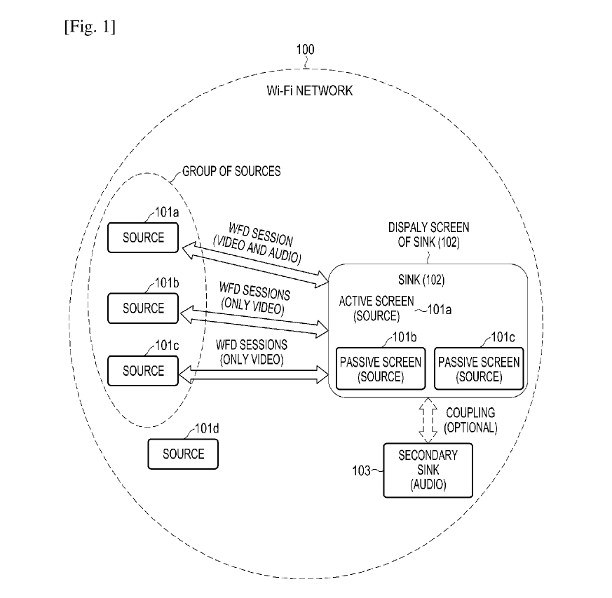

Referring now to the drawings, and more particularly to FIGS. 1 through 7, where similar reference characters denote corresponding features consistently throughout the figures, there are shown preferred embodiments.

FIG. 1 illustrates an example WFD environment with one or more sources in a group simultaneously streaming multimedia content to the sink by establishing one or more WFD sessions, according to embodiments as disclosed herein. The figure depicts source 101a (first source) and sources 101b, 101c and 101d (one or more secondary sources) respectively in a Wi-Fi network 100. The sink 102 is primary sink capable of mirroring audio, video of the multimedia contents during the WFD sessions established by the sources 101a, 101b, 101c respectively. The sink 102 can have an optional coupling to a secondary sink 103 which is an audio sink.

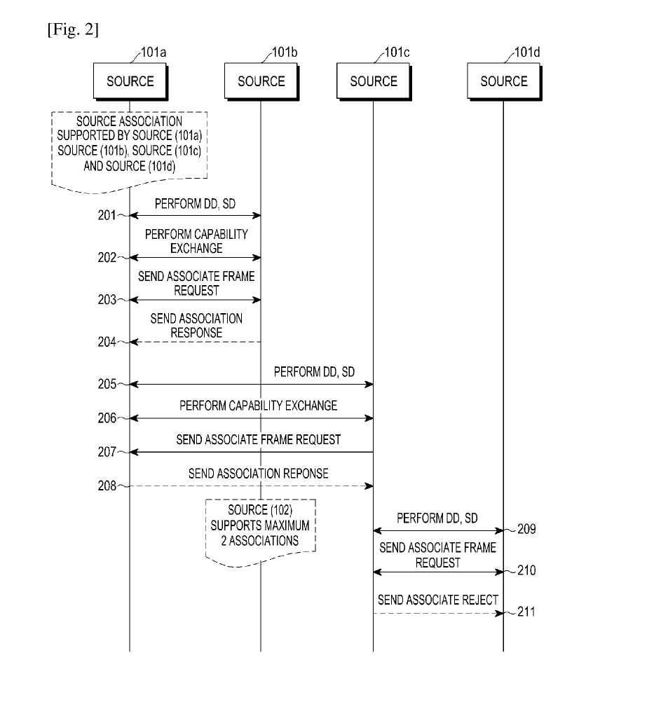

The sink 102 discovers source association information comprising the audio intent value and mode of operation from the source 101a and source 101b and source 101c by performing capability exchange. Based on the discovered mode of operation the WFD sessions are established between the sink 102 and each of the sources 101a, 101b and 101c respectively. The source 101a, 101b and 101c are member of single group and each source establishes the WFD session with the sink 102. As depicted in figure, if the sink 102 is configured to support only three sources for the streaming multimedia contents, the sink 102 restricts additional source 101d to be the member of group in any selected mode of operation for streaming the multimedia contents. The mode of operation of the established WFD sessions for streaming of multimedia contents can be the associated mode, the unassociated mode or the part display mode. Above mentioned modes are described in the FIGS. 2 to 7. The unassociated mode comprises a pre-grouping mode and a post grouping mode of operation for streaming of the multimedia contents.

The mode of operation defines the way the group is formed. In the associated mode, the plurality of sources, form the group among themselves prior to establishing the WFD session with the sink. In the post grouping mode, the group is formed by the sink after the WFD session starts with one of the source. In the pre-grouping mode the group is formed by the sink before start of WFD session with either of the source.

The source 101a, 101b and 101c are members of single group and each source establishes the WFD session with the sink 102.

In an embodiment, based on the application the method can choose to operate in one of the operating modes. For example, a delay in the WFD session establishment by the application on the source results in pre-grouping mode of operation, whereas immediate WFD session establishment by the application on the source results in post-grouping.

A sink group that includes the sink and the plurality of sources comprising the first source and at least one second source can be identified using a unique identifier called Group ID. The Group ID is the application level identifier for the group and the sink can have only one group supported at a time. Thus, the method enables usage of the Sink ID as the Group ID.

In an embodiment, the sink receives information for the mode of operation in the source association information from one or more sources in the Wi-Fi network 100 using a new message M20. The M20 can either be a separate ModeSelect frame or an RTSP command. For example, the method defines a new message M20. The ModeSelect frame is a dummy frame with no data or some data relevant for the WFD sessions for that selected mode of operation.

In an embodiment, the sink can select and inform the mode of operation to one or more sources during the capability exchange by sending an operation mode parameter indicating the selected mode of operation. The operation mode parameter can have three distinct values corresponding to the associated mode, the pre-grouping mode and the post grouping mode.

In an embodiment, the audio intent value enables the sink to assign active status to one of the source which is the member of the group.

As depicted in figure, the sink 102 assigns active status to source 101a that has highest audio intent value and minors source's 101a audio and video on the display screen of the sink 102. The sink assigns passive status to remaining members of the group (sources 101b and 101c) and renders only the video of the sources 101b and 101c respectively on the display screen of the sink 102.

In an embodiment, if the audio intent values of the sources 101a, 101b and 101c respectively are equal, then the sink 102 is configured to select the source which can be assigned with active status. The sink 102 chooses the source to assign the active status based on other parameters such as resources available with the source, audio formats supported and the like.

The audio intent value is only an indication or request by the source to acquire the active source status and the sink can accept or reject the received indication.

In an embodiment, the sink 102 displays video of sources 101a, 101b and 101c respectively and audio is played by the active source 101a using its own resources.

In an embodiment, the sink 102 can switch the active and passive status of each source based on application level logic in the sink 102 or whenever the sink receives request from the passive source for assigning active source status.

The way the sink 102 displays the video from each source is based on configuration settings on the sink 102. For example the sink can choose either to split the screen horizontally or vertically based on number of sources that are associated to a group or in a way that seems suitable for the type of content to be displayed.

In an embodiment, the configuration settings for the sink can be sent from the source to the sink.

In an embodiment, when sink 102 operates in coupled sink mode, then audio for source assigned with active status is transferred to the secondary sink 103 (dedicated audio sink). The existing passive status of remaining sources is unchanged. In an embodiment of coupled sink mode, if the current application demands, the free audio resource of sink 102 (primary sink) can be used for source 101b or source 101c which are assigned with passive status for the established WFD sessions.

In an embodiment, the sink mirrors multiple streams sent from a single source. The sink assigns one stream among the multiple streams as active stream to mirror the audio and video of the active stream. The remaining streams are assigned passive status and only video of the passive streams is displayed on the display of the sink.

FIG. 2 illustrates a sequence diagram explaining formation of a pre-association group for establishing one or more WFD sessions in associated mode of operation, according to embodiments as disclosed herein.

For the associated mode of operation, the pre-association group of sources is formed (created) after plurality of sources comprising the first source and one or more second sources join as member of the pre-association group. This creates a source association between these members before initiating the WFD session with the sink To enable source association between pluralities of sources in the Wi-Fi network 100 for creating or forming the pre-association group the method provides a source association procedure. The source association may or may not be supported by all sources in the Wi-Fi network 100. The method enables the plurality of sources in the Wi-Fi network 100 to indicate their support for the source association capability using a parameter Source_Association_Support during capability exchange message flows. The Source_Association_Support parameter set to a value 1 (true) indicates that the source supports associated mode source association between the plurality of sources and a value of 0 (false) indicates the source does not support associated mode source association between the sources. The method provides a capability parameter Associated_Source in the capabilities of the source association capable one or more sources in the Wi-Fi network 100. The value of the Associated_Source parameter is set to 1 (true) by the source if the source is associated with at least one other source; else the value is set to 0 (false).

The method provides a parameter No_Of_Sources_Associated to the source association capable one or more sources to maintain a count of number of associated sources in the pre-associated group. When the source is not associated with any other source the value of No_Of_Sources_Associated is set to 0 (false) and is incremented by one with every new source association with other source association capable sources.

In an embodiment, the sources can set a limit on number of source associations using a parameter Max_Source_Associations. The value of the Max_Source_Associations provides maximum allowed source associations for the source. For example: if a source indicates its Max_Source_Associations as 2, it is unable to associate with more than 2 other source.

The source association procedure happens sequentially and at any point of time a source can run source association procedure with only one source.

As depicted in the figure, the source 101a (first source), source 101b, source 101c, source 101d (one or more second sources) with their Source_Association_Support parameter set to value 1 indicate their capability to support source association. Further, the figure depicts exchange of messages for performing the source association procedure to form the pre-association group. Initially, as none of the sources are associated with each other, all sources 101a, 101b, 101c and 101d respectively have the No_Of_Sources_Associated parameter value set to 0. The source 101a and source 101b in the Wi-Fi network 100 discover each other by performing (201) Device Discovery (DD) and an optional Service Discovery (SD).

Upon performing the DD and SD a Transmission Control Protocol (TCP) connection is established between the source 101a and source 101b. Further, both initiator source 101a and discovered source 101b perform (202) capability exchange by exchanging RTSP messages M1 to M4. Once capability exchange procedure is performed, the source 101a and source 101b identify whether each of them supports source association by verifying the value of Source_Association_Support. If any source fails to support the source association, then the source association procedure for the corresponding source is terminated.

If source association is supported by the source 101a and source 101b, then the source association procedure steps can be performed. As described, initially source 101a and source 101b are not associated with any other source, the parameter; No_Of_Sources_Associated is set to 0 by both the sources. Either of the source 101a or source 101b can initiate the source association procedure. The source 101a initiates a request for performing source association and sends (203) a new M17 RTSP command such as associate frame request to source 101b. In response, the source 101b sends (204) a new M18 RTSP response with association response, indicating the source association is successful. The association request and association response frames are dummy frames without data.

In an embodiment, data relevant for the source association procedure can be included in the association request and association response frame.

Once source association is successful both source 101a and source 101b update their Associated_Source parameter to 1 and No_Of_Sources_Associated parameter to 1. Further, the association with the source 101c can be initiated by source 101a, source 101b or the source 101c itself. As depicted in the figure, source 101c the starts source association with source 101a. The source 101c performs (205) DD, SD, performs (206) capability exchange, sends (207) associate frame request and receives the association frame response sent (208) by source 101a, indicating successful association. Upon successful association with one of the member (source 101a) of the pre-associated group, the source 101c is automatically associated with the entire members in the pre-associated group such as source 101b in FIG. 2.

Further, any other source in the Wi-Fi network 100 such as source 101d interested in joining the pre-associated group can start the source association procedure and performs (209) DD, SD with one of the member of the pre-associated group (source 101c). The source 101b has Max_Source_Associations value set to 2 indicating it is unable to associate with more than two devices. As source 101b, is already associated to two other sources (source 101a and source 101b). The source 101d sends the associate frame request to source 101c. The request is rejected by the source 101c as the Max_Source_Associations value of source 101b limits any further expansion of the pre-associated group. The source 101c sends (211) an association reject message in response to request from source 101d.

In an embodiment, the sources in the Wi-Fi network may be capable of joining multiple pre-association groups. The method enables the sources to indicate multi association capability in its capabilities using a new Multi_Association_Capable parameter. The Multi_Association_Capable parameter value set to 1 (true) indicates the source is multi association capable and value set to 0 (false) indicates the source is not Multi Association capable.

In an embodiment, the source 101d which was rejected by the pre-association group formed between source 101a, source 101b and source 101c can start source association procedure with source 101a or source 101c if these sources are multi association capable. The new source association of source 101a and/or source 101c is independent of previous source association performed for forming the pre-associated group with the source 101b and source 101c.

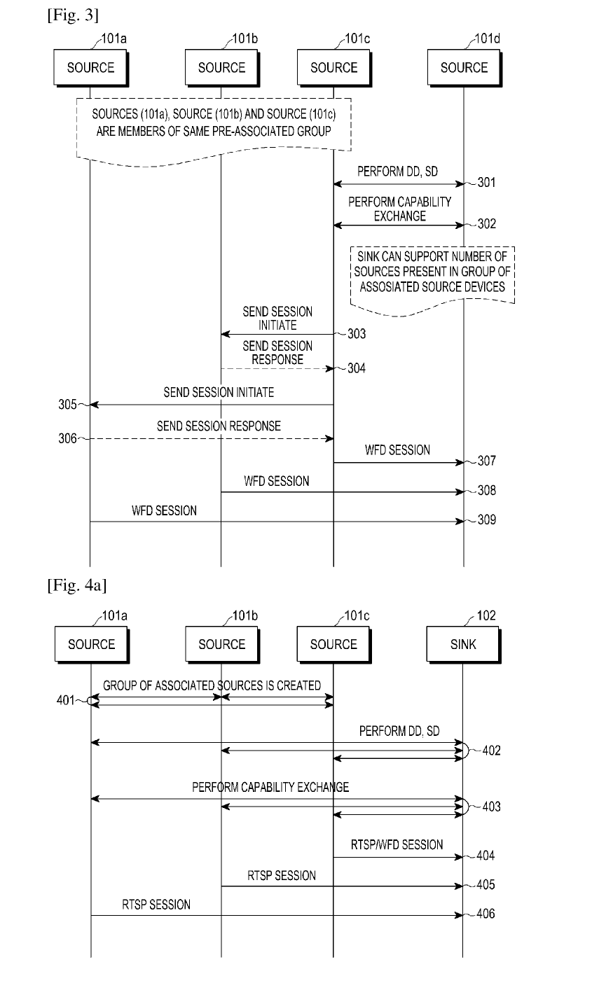

FIG. 3 illustrates a sequence diagram explaining establishment of one or more WFD sessions by one or more sources in the pre-associated group with the sink for associated mode of operation, according to embodiments as disclosed herein. As depicted in the figure, the sources 101a, 101b and 101c respectively form the pre-associated group of sources. Either of the members of the pre-associated group can initiate the WFD session.

As depicted in figure, source 101c initiates the WFD session for the pre-associated mode of operation and performs (301) DD, SD by exchanging messages with the sink 102. Further, the capability exchange is performed (302) between the source 101c and the sink 102.

The sink may or may not be able to support more than specific number of sources for the WFD sessions. The method enables the sink to indicate the number of sources supported for the selected mode of operation in the sink's capabilities using a Max_Source_Supported parameter.

During the capability exchange performed, the sink 102 determines the number of sources (members) in the pre-associated group that initiates the WFD session. The parameter No_Of_Sources_Associated which is set within source 101c enables the sink to know the number of sources (members) in the pre-associated group.

At this step, the source 101c determines if the sink 102 supports the number of members in the pre-associated group by checking if No_Of_Sources_Associated parameter value set in the source 101c is less than or equal to the Max_Source_Supported parameter of the sink 102. As depicted in the figure, the sink 102 supports the number of members in the pre-associated group and the support is conveyed to the source 101a during the capability exchange performed. Upon confirmation of the sink support for the pre-associated group, the method enables the source 101c to inform the members of the pre-associated group about the sink support using a new separate SessionInitiate frame. The SessionInitiate frame is a dummy frame without any data.

In an embodiment, a new M19 RTSP command is used for indicating the sink support for the pre-associated group. The source 101c sends (303) the session initiate message to source 101b which sends (304) a session response as an acknowledgement for initiating the WFD session. Further, the source 101c sends (305) the session initiate message to source 101a which sends (306) the session response as the acknowledgement for initiating the WFD session. Once every member in the pre-associated group receives the session initiate message and responds to the message, the each member of the pre-associated group executes (307, 308, 309) the usual sequence of WFD session setup procedures with the sink 102 starting from DD, SD, capability exchange and the actual WFD session.

If a non-member source is interested in joining the pre-associated group, the existing pre-associated group has to be torn down to form a new pre-associated group.

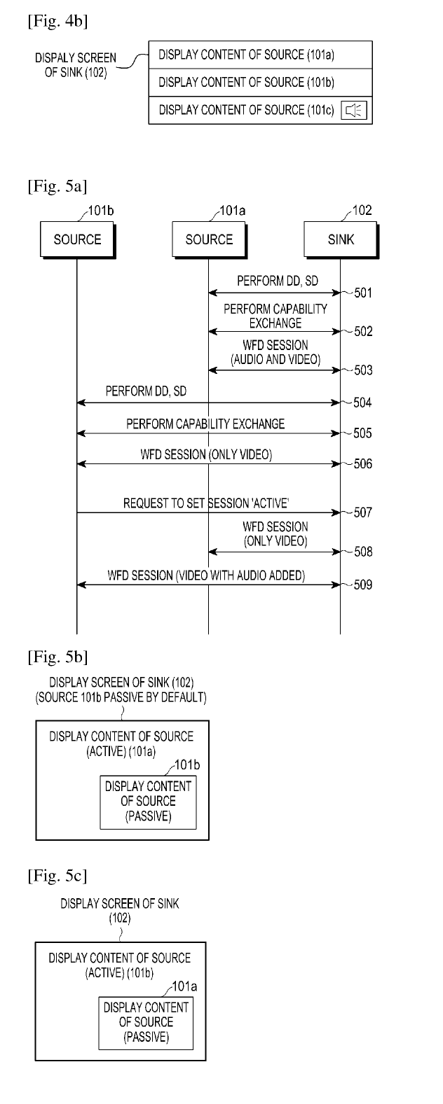

FIG. 4a illustrates an example sequence diagram for a multiplayer game by establishing one or more WFD sessions in the associated mode of transmission and FIG. 4b illustrates corresponding display screen of the sink, according to embodiments as disclosed herein. As depicted in the FIG. 4a the sources 101a, 101b and 101c respectively exchange messages to create (401) or form the pre-associated group by performing source association procedure as described in FIG. 2. The sink 102, supports the number of members in the pre-associated group and as described in FIG. 3 every member of the pre-associated group (sources 101a, 101b and 101c respectively) perform (402) DD, SD and perform (403) capability exchange with the sink 102 a. Further sources 101a, 101b and 101c respectively individually establish (405, 406 and 407) WFD session with sink 102. The sink 102 allows video WFD sessions for the sources 101a, 101b and 101c respectively. Further, one of the chosen sink which is assigned the active status is allowed to establish video and audio session. Further, the sink renders audio of the chosen sink along with video of all the sources 101a, 101b and 101c respectively.

In an embodiment, the sink enables the chosen sink to play the audio using the audio resources of the active status source and establishes only video WFD sessions with each source.

The FIG. 4b depicts the display screen of the sink 102, with the sink 102 sharing the display screen equally. The figure depicts source 101c is chosen, assigned active status by the sink 102 and audio of only source 101c is played. The sink 102 provides indication for chosen active source to the user.

In an embodiment, the indication can be a speaker logo, a text ‘ACTIVE’, a text ‘AUDIO’ and the like displayed on the shared sink screen space corresponding to the selected active source.

For example, source association between the sources may be required in the case where the screen resources of the sink are shared equally between the sources. This can be applicable usually in the multiplayer interactive gaming applications scenario where every player with his/her own source such as the smart phone, the tablet and the PDA form the associated group. Once the associated group is formed, these sources simultaneously stream their video to the smart TV screen (sink). The smart TV displays the video from each source on the display screen by distributing screen space equally among the associated sources. The smart TV renders audio of one of the selected source such as the PDA (assigned with active source status) whenever the gaming session is active for the PDA user. Whenever the gaming session for the PDA user ends, the smart TV assigns active source status to the tablet and renders audio from the tablet along with the video of all the associated sources being displayed on the screen.

The details about which source is running the game and how each source interacts with another source for acquiring the game content are dependent on implementation details of the multi-player game or similar applications. The method assumes that each source has its audio and video.

FIG. 5a illustrates a sequence diagram explaining establishment of one or more WFD sessions for a post grouping mode in the unassociated mode of operation and, FIG. 5b, FIG. 5c illustrate corresponding display screens of the sink, according to embodiments as disclosed herein.

Any source in the Wi-Fi network 100 can operate in the unassociated mode of operation if the source has not performed source association procedure as described in FIG. 2 with any of the other sources in the Wi-Fi network 100 device. If such a source communicates with the sink 102, the sink 102 operates in the unassociated mode.

The remaining sources that may join to form a group for the unassociated mode of operation are assigned passive source status by the sink 102. The passive status sources are provided with only Picture in Picture (PIP) screen share of the sink 102 with only video session supported for them. For example, the video for PIP may be a very basic format and need not be of high quality like High Definition (HD). The number of PIP screens supported by the sink can be limited and the method enables the sink to indicate the PIP limitation in its capability using a parameter No_Of_PIP_Supported.

In an embodiment, based on the multimedia content displayed on the screen the method enables the sink to render audio and video from one of the passive source status sources that are assigned PIP share of the screen while displaying only video of the selected active source that is provided with major portion of the screen. For example, in the post-grouping mode the laptop (source) is assigned with the passive source status and gets PIP share of the screen space. The method enables the smart TV (sink) to mirror audio and video for a movie from the laptop. The smart camera is assigned the active source status and gets major portion of the screen to display the images (only video). Thus, the user can enjoy watching images from his camera while keeping track of the movie being played as PIP.

The unassociated mode comprises two modes of operation the post-grouping mode and the pre-grouping mode. The sink and the sources operate in the post-grouping mode when the group is formed by the sink after the WFD session starts with one of the sources in the Wi-Fi network 100.

The post-grouping mode of operation is based on certain predefined rules such as: The first source to perform the DD, SD and capability exchange with the sink is assigned the active source status by default. As new sources start DD, SD and capability exchange, irrespective of their audio intent value, they are treated as passive sources and assigned passive source status by the sink Any source in the Wi-Fi network 100 if interested in becoming the active source should explicitly request the sink about the intent.

As depicted in the FIG. 5a, the source 101a performs (501) DD, SD and performs (502) capability exchange with the sink 102. The sink 102 identifies the mode of operation for the WFD session to be established during the capability exchange between the source 101a and the sink. Further, the source 101a starts (503) the WFD session with the sink 102. The sink 102 assigns active source status to the sink 101a allowing the source 101a to establish audio and video WFD session, enabling the source 101a to transfer both video and audio to the sink 102. The source 101a, assigned with active status receives the main portion of the display screen of the sink 102 as depicted in FIG. 5b. Thereafter, the source 101b performs (504) DD, SD and performs (505) capability exchange with the same sink 102. Further, the sink 102 assigns passive status to the source 102 and allows establishment of only video WFD session. The video of the source 102 is displayed as a PIP on the display screen of the sink 102 as depicted in FIG. 5b. The audio session is disallowed for source 101b as it is assigned passive status.

Thereafter, if at any later instant of time, the source 101b is interested in becoming the active source, the source 101b requests (507) the sink 102 by sending set session active request for the same. The sink 102 can accept (honor) or reject the request. As depicted in the FIG. 5a, the sink accepts the request and assigns active status to the source 101b and switches the source 101a to passive status. Once the status of the source 101a and 101b are switched, the WFD session with only video is established (508) between the source 101a and the sink 102. Further, the WFD session with audio and video is established (508) between the source 101b and the sink 102 which now renders the audio of source 101b. As depicted in FIG. 5c, the sink 102 then switches the shared display screen with major share to the new active source 101b and PIP for the new passive source 101a.

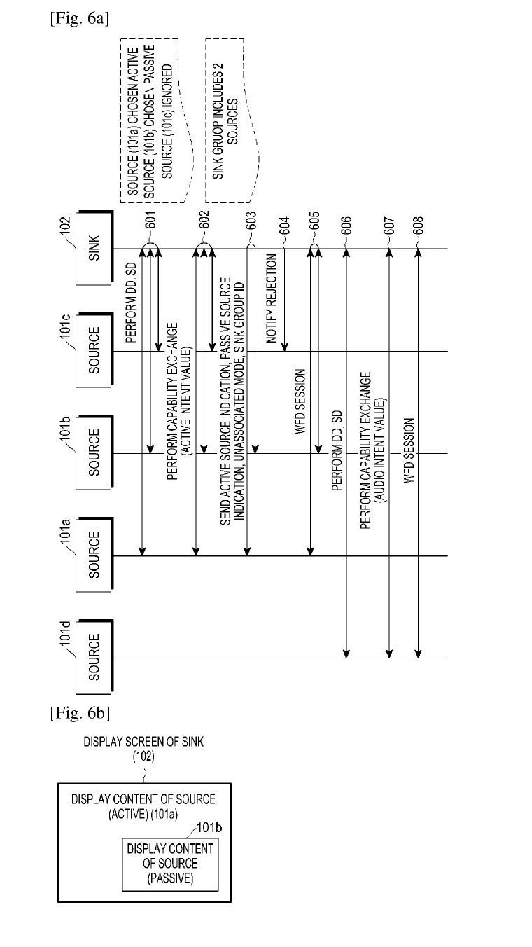

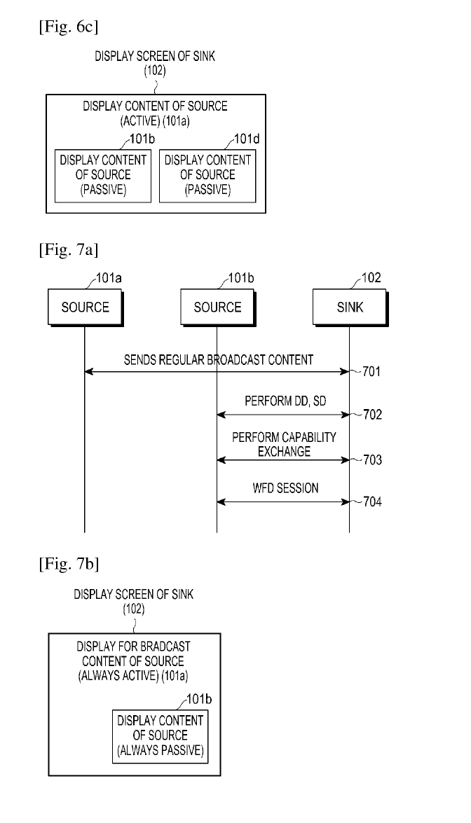

FIG. 6a illustrates a sequence diagram explaining establishment of one or more WFD sessions for a pre-grouping mode in the unassociated mode of operation and, FIG. 6b, FIG. 6c illustrate corresponding display screen of the sink, according to embodiments as disclosed herein. In the pre-grouping mode of operation the group is formed by the sink after DD, SD and capability exchange is performed with each source in Wi-Fi network 100 that is interested in joining the group but before WFD session is established between the sink and any of these sources. The method defines some rules for the pre-grouping mode of operation such as: The DD, SD and capability exchange of each source happens independently with the sink. The active and passive sources are chosen by the sink and are informed about the status by the sink. The WFD session starts between the sink and each of the sources in the group. If the sink can support more number of sources, new sources can join the group by performing DD, SD and capability exchange but these sources are assigned passive status at the time of joining the group of the pre-grouping mode of operation.

As depicted in the FIG. 6a, the source 101a, 101b and 101c respectively perform (601) DD, SD with the same sink 102 independently.

The source 101a, 101b and 101c respectively perform (602) capability exchange providing audio intent value to the sink 102 embedding their intent to become active source. The sink responding to request by sources 101a, 101b and 101c respectively for joining formed group by accepting or rejecting the request during the capability exchange. The sink 102 can accept or reject the sources to form a group based the Max_Source_Supported or the like parameters.

Based on the audio intent values, the sink 102 chooses source 101a as active source and source 101b as passive source. The source 101c is ignored by the sink for inclusion in group formation for the pre-grouping mode. The sink group formed for pre-group mode includes the sink 102, the source 101a and source 101b. Further the sink 102 sends (603) information to the source 101a and 101b respectively providing the active source indication (source 101a active status), the passive source indication (source 101b passive status), unassociated mode (current selected mode of operation) and the sink group ID assigned as unique identifier to the formed group. Further, the sink 102 notifies (604) the source 101c about its rejection by the sink 102 for inclusion in the sink group. Thereafter, the sink 102 allows establishment (605) of audio and video WFD session for source 101a and video WFD session for source 101b.

The FIG. 6b depicts the display screen of the sink 102 with major portion of the screen display to the active source 101a and PIP for source 101b.

Further, another source 101d performs (606) DD, SD and performs (607) capability exchange with the sink 102 providing the audio intent value. By default the sink 102 chooses source 101d as passive source. The sink 102 can accept or reject the request from the source 101d based on one or more parameters such as No_Of_PIP_Supported by the sink 102 and similar parameters. If the sink 102 accepts the request, the source 101d is assigned passive status by the sink 102. Thereafter, the source 101d establishes (608) only video WFD session with the sink 102.

FIG. 7a illustrates a sequence diagram explaining establishment of one or more WFD sessions for the part display mode of operation and FIG. 7b illustrates corresponding display screen of the sink, according to embodiments as disclosed herein.

In the part display mode the sink can use mirroring using the WFD session only on a part of the display screen of the sink. The part display mode is a sub case or special case of the picture in picture scenario described in FIG. 5a and FIG. 6a, except that the sink does not have any control on the source with active status. The method defines rules that apply for the part display mode such as: The sink can select to use only part of its display screen for WFD purposes. The sink indicates this to the WFD source interested in establishing the WFD session during capability exchange between the source and sink. The source assigned the active status is the default behavior of sink Usually any broadcast or local content are assigned active source status.

As depicted in the FIG. 7a the active source 101a is already is utilizing the sink 102 and sends (701) regular broadcast content to the sink 102. For example, the regular broadcast content can be the television channel content from the cable operator. The sink 102 has no control over the active (main) source 101a. The source 101b, which is interested in utilizing the sink 102a for the WFD session in part display mode performs (702) the DD, SD and performs (703) capability exchange with the sink 102.

The method enables the sink to indicate the source 101b for its support for the part display mode using a new Part_Display_Support parameter during the capability exchange. The value of Part_Display_Support parameter is set to 1 (true) if the sink 102 supports the part display mode. The value of the Part_Display_Support parameter is set to 0 (false) if the sink fails to support part display mode.

Upon performing capability exchange, the WFD session for the part display is established (704) as sink 102 supports the part display mode. The status assigned to the source 101b is always passive and hence always is the video session with the PIP screen space. The WFD session established is usually non HD.

FIG. 7b depicts the display screen of sink 102 with broadcast content from active (main source) being displayed on major part of the display screen of sink 102 and the content from passive source 101b with PIP mode.

The above embodiments can be also applied to a security service. For example, assuming a security network environment that a security officer monitors the videos from multiple security cameras in a corporate office on the big screen in security room, all the security cameras and the big screen can be implemented by using Wi-Fi Display devices where the security cameras act as the Source and big screen like TV acting as the Sink. The security cameras and the TV are connected over Wi-Fi Infrastructure or Wi-Fi Direct or TDLS. Wi-Fi Display sessions run between the security cameras and the big screen TV. Given this situation there are multiple possible operation modes (that is, Scenarios 1, 2) described below.

Scenario 1: Number of security cameras is less and all videos can be displayed on TV

1) Security Cameras discover the TV and start Wi-Fi Display session

2) TV can divide its screen and provide resources to each security camera to display its video content. But the audio from only one source can be heard on the TV

3) So each source device would have an audio intent value which is shared with the sink device i.e. TV

4) The audio from source with highest intent is selected for audio rendering on the TV

5) The audio intent value is dynamic and depends on the state of the source device. For example when a source device notices a certain emergency event it will increase its audio intent value to highest level and immediately sends the value to the sink device.

6) The sink device understands this intent value and accepts the audio from this source device.

Scenario 2: Number of security cameras is large and all videos cannot be displayed on TV

1) TV cannot provide resources to all security cameras in large corporate office and hence will provide resources to only some cameras located in important parts of the office like entrance, exits etc.

2) These important Security Cameras discover the TV and start Wi-Fi Display session

3) As usual the audio from only one source is played on the TV whose audio intent value is highest

4) The other Video cameras (passive) though are monitoring the area and recording the happenings they will not be streaming the content (both video and audio) to the TV. The video display on TV is also defined based on the video intent value which is minimal for these passive video cameras

5) The video intent value is dynamic and depends on the state of the source device. For example when a source device notices a certain emergency event it will increase its video intent to highest value. This will automatically increase the audio intent also to highest value too. These intent values are immediately sent to the sink device

6) The sink device understands the invent value changes and displays video of the source device and also plays audio to get attention of the security personal

7) Alternatively, instead of the intent values an emergency event notification is sent from source to the sink device which the sink device will interpret and provides resources to both video and audio from that particular source.

In both the scenarios above, the intent value in source device changes because of occurrence of some emergency events. The events could be any one of the 1) to 4) events described below:

1) Audio recorded above certain decibels on the source device

2) Motion detection on source device using motion sensor

3) Quick Video Frame Changes in recorded video at the source

4) Operator manually selecting a camera etc.

The embodiments disclosed herein can be implemented through at least one software program running on at least one hardware device and performing network management functions to control the elements. The elements shown in FIGS. 1, 2, 3, 4, 5, 6 and 7 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A method for streaming multimedia content in a Wireless Fidelity (Wi-Fi) network, wherein said method comprises:
discovering source association information by a sink during capability exchange between said sink and at least one of a first source and at least one second source after performing Device Discovery (DD) and Service Discovery (SD);
establishing at least one Wi-Fi Display (WFD) session between said sink and at least one of: said first source and said at least one second source for streaming said multimedia content in said Wi-Fi network;
displaying video of said multimedia content from said first source and said at least one second source by said sink, wherein screen of said sink is shared among at least one of said first source and said at least one second source; and
rendering audio of said multimedia content by said sink after selecting said audio from one of: said first source, said at least one second source.

2. The method as in claim 1, wherein said discovered source association information by said sink further comprises at least one of: an audio intent value, and a mode of operation of said first source and said at least one second source.

3. The method as in claim 1, wherein said mode of operation for said at least one WFD session comprises one of: an associated mode, an unassociated mode and a part display mode of said sink and said first source and said at least one second source.

4. The method as in claim 3, wherein said unassociated mode comprises one of: a post grouping mode and a pre-grouping mode of operation.

5. The method as in claim 3, wherein said method further comprises receiving said mode of operation, by said sink, in said discovered source association information from at least one of: said first source and said at least one second source using one of: a ModeSelect frame and a Real Time Streaming Protocol (RTSP) command.

6. The method as in claim 3, wherein said method further comprises selecting and informing said mode of operation to said first source and said at least one second source, by said sink, during said capability exchange by sending an operation mode parameter indicating said selected mode of operation.

7. The method as in claim 1, wherein said method further comprises selecting said audio to be rendered based on an audio intent value associated with said first source and said at least one second source.

8. The method as in claim 3, wherein said associated mode comprises receiving initiation request for said WFD session from a member of a pre-associated group, wherein said member is one of: said first source, said at least one second source.

9. The method as in claim 8, wherein creating said pre-associated group further comprises:
performing Device Discovery (DD), Service Discovery (SD) and said capability exchange between said first source and said at least one second source to determine if said first source and at least one second source support said associated mode, wherein said support is indicated by said first source and said at least one second source using a Source_Association_Support parameter during said capability exchange;
starting a source association procedure between said first source and said at least one second source by one of said first source and said one of second source, if said Source_Association_Support parameter is true, to form said pre-associated group using RTSP commands, wherein said RTSP commands comprises an associate frame request and an associate frame response; and
expanding said pre-associated group based on parameters configured in said first source and said at least one second source, wherein said parameters comprise at least one of number of associated sources in said pre-associated group (No_Of_Sources_Associated), maximum allowed source associations (Max_Source_Associations), and capability for forming multiple source groups (Multi_Association_Capable).

10. The method as in claim 8, wherein said method further comprises responding to said initiation request by:
determining, by said member, if said sink supports number of members in said pre-associated group, wherein said determining comprises comparing said No_Of_Sources_Associated with a maximum number of members supported by said sink (Max_Source_Supported);
informing said members of said pre-associated group to initiate said WFD session in said associated mode using a RTSP session initiate frame command, if said sink supports said No_Of_Sources Associated in said pre-associated group; and
sharing said screen of said sink to said members of said pre-associated group by said sink based on configuration settings of said sink for said pre-associated group to mirror said multimedia content streamed by said members.

11. The method as in claim 4, wherein said post grouping mode comprises:
establishing said WFD session with said first source by said sink after said first source initiates said WFD session, wherein said first source is assigned an active source status by said sink;
establishing said WFD session with said at least one second source by said sink after said at least one second source initiates said WFD session based number of Picture in Picture (PIP) screens supported (No_Of PIP_Supported) by said sink;
assigning passive source status to said at least one second source; and
mirroring said video, said audio of said first source and video of said at least one second source to said sink.

12. The method as in claim 11, wherein said method further comprises requesting said sink by said at least one second source with intent to acquire said active source status, further said sink is configured to perform one of: accept and reject said received request from said at least one second source.

13. The method as in claim 4, wherein said pre-grouping mode comprises:
forming a group after performing capability exchange between said first source, said at least one second source with said sink;
assigning said active source status to a member in said formed group and said passive source status to remaining members in said formed group; and
mirroring to said sink, said video and said audio of said member assigned with said active source status and video of said remaining members assigned with said passive source status.

14. The method as in claim 13, wherein said method further comprises said sink responding to a request by said at least one second source for joining said formed group by one of: accepting and rejecting said request during said capability exchange.

15. The method as in claim 3, wherein said part display mode comprises:
displaying said video and rendering said audio of said first source assigned with said active source status by said sink, wherein said first source is a main source of said sink;
providing part display support indication to said at least one second source during said capability exchange using Part_Display_Support parameter by said sink, wherein value of said parameter is one of: true, false;
indicating said sink with intent to use said part display mode by a source among said at least one second source if said provided Part_Display_Support parameter value is set to true;
assigning said passive status to said source by said sink; and
sharing said screen to display said video of said source assigned with said passive status on part of said screen by said sink.

16. A system for streaming multimedia content in a Wireless Fidelity (Wi-Fi) network, wherein said system comprises a first source, at least one second source and a sink wherein said system is configured to:
discover source association information by said sink by performing capability exchange between said sink and at least one of said first source and said at least one second source after performing Device Discovery (DD) and Service Discovery (SD);
establish at least one Wi-Fi Display (WFD) session between said sink and at least one of: said first source and said at least one second source for streaming said multimedia content in said Wi-Fi network;
display video of said multimedia content from said first source and said at least one second source by said sink, wherein screen of said sink is shared among at least one of said first source and said at least one second source; and
render audio of said multimedia content by said sink after selecting said audio from one of: said first source, said at least one second source.

17. (canceled)
